(19) United States
(12) Patent Application Publication
(10) Pub. No.: US 2026/0046324 A1
(43) Pub. Date: Feb. 12, 2026

(54) METHOD AND DEVICE FOR CONNECTING COMPUTERS

(71) Applicant: TRUMPF Werkzeugmaschinen SE + Co. KG, Ditzingen (DE)

(72) Inventors: Marcel Ely Gomes, Stuttgart (DE); Thorsten Larsen-Vefring, Stuttgart (DE); Klaus Bauer, Ditzingen (DE)

(21) Appl. No.: 19/366,552

(22) Filed: Oct. 23, 2025

Related U.S. Application Data
(63) Continuation of application No. PCT/EP2024/059831, filed on Apr. 11, 2024.

(30) Foreign Application Priority Data
Apr. 24, 2023 (DE) 10 2023 110 365.2

(51) Int. Cl. H04L 65/1069

(52) U.S. Cl. CPC H04L 65/1069

(57) ABSTRACT

A method for connecting a first and second computer via a first and/or second communication connection enabling connection of the computers. The communication connections each have at least one first connection property. At least two application variants have a prioritization order. The method includes selecting an application variant with the highest priority and checking whether the requirements of the selected application variant are met by one of the first and second communication connections. The method further includes selecting, based on a determination that the requirements of the selected application variant are not met, an application variant of the at least two application variants with the next lowest priority and repeating steps of the method. The method further includes connecting the first computer and the second computer via the first and/or second communication connection such that the requirements of the selected application variant for the first connection property are met.

### CROSS REFERENCE TO RELATED APPLICATIONS

This application is a continuation of International Application No. PCT/EP2024/059831 (WO 2024/223315 A1), filed on Apr. 11, 2024, and claims benefit to German Patent Application No. DE 10 2023 110 365.2, filed on Apr. 24, 2023. The aforementioned applications are hereby incorporated by reference herein.

### FIELD

The invention relates to a method for connecting a first computer and a second computer, to a connecting device for carrying out the method, and to a system for carrying out the method.

### BACKGROUND

A device for selecting a communication connection is known from WO 00/22788 A1.

### SUMMARY

In an embodiment, the present disclosure provides a method for connecting a first computer and a second computer via a first communication connection and/or a second communication connection, wherein the first communication connection and the second communication connection enable a connection of the first computer and the second computer. The first communication connection and the second communication connection each have at least one first connection property. At least one application is executed on the first computer. The at least one application has at least two application variants having different requirements for the first connection property. The at least two application variants have a prioritization order. The method comprises selecting an application variant of the at least two application variants with the highest priority and checking whether the requirements of the selected application variant are met by one of the first and second communication connections. The method further comprises selecting, based on a determination that the requirements of the selected application variant are not met by a communication connection, an application variant of the at least two application variants with the next lowest priority and repeating steps of the method. The method further comprises connecting the first computer and the second computer via the first communication connection and/or the second communication connection such that the requirements of the selected application variant for the first connection property are met.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic representation of a system according to an embodiment of the present disclosure;

FIG. 2 illustrates a flow chart of a method according to an embodiment of the present disclosure;

FIG. 3 illustrates a further schematic representation of a system according to an embodiment of the present disclosure;

FIG. 4 illustrates connection properties of the communication connection from FIG. 3; and

FIG. 5 illustrates requirements of the applications from FIG. 3.

### DETAILED DESCRIPTION

In an embodiment, the present disclosure provides a method which improves the selection of a communication connection.

The foregoing improvements are achieved by a computer-implemented method for connecting a first computer and a second computer via a first communication connection and/or a second communication connection, the first communication connection and the second communication connection enabling a connection of the first computer and the second computer, and the first communication connection and the second communication connection each having at least one first connection property, at least one application being executed on the first computer, and the first application having at least two application variants having different requirements for the first connection property, and the application variants having a prioritization order, having the steps of:
a) selecting the application variant with the highest priority;
b) checking whether the requirements of the selected are met by one of the communication connections;
c) if the requirements of the selected application variant are not met by a communication connection, the application variant with the next lowest priority is selected and the method is repeated from step b),
d) connecting the first computer and the second computer via the first communication connection and/or the second communication connection such that the requirements of the selected application variant for the first connection property are met.

Which communication connection is used to establish the connection between the first computer and the second computer depends on the requirements of the application. The application offers at least two application variants with different requirements. The application variants can, for example, be minimum operation for the first application variant and optimal operation for the second application variant. The application variants have a priority order. For example, optimal operation can have a higher priority than minimum operation. The connection is therefore preferably established to suit optimal operation. If the requirements of optimal operation cannot be met, the connection is established to suit minimum operation.

The requirements of the application variants for the connection property can be a minimum value or a maximum value depending on the category. The connection property of the communication connection should therefore be greater than or equal to the minimum value and less than or equal to the maximum value.

The priority can be specified explicitly or implicitly by the requirements. For example, a higher priority can be assumed for an application variant with stricter requirements, in particular a higher bandwidth and/or a lower latency, than for an application variant with weaker requirements. Alternatively, a higher priority can be assumed for an application variant with low costs than for an application variant with high costs. If the priority is the same, the order can be determined randomly or depend on another parameter. The priority can be calculated using a mathematical function from the requirements, in particular from some of the requirements, especially from the cost requirements.

The communication connections can, for example, be access lines to the Internet. The connection between the first computer and the second computer is then established via the access line and the Internet. Such access lines can, for example, use different technologies, such as copper cables, fiber optics or mobile communications, and therefore have different connection properties. Even with the same technology, different connection properties can exist, e.g., due to different providers or different limited offers from the same provider. The first communication connection and the second communication connection can therefore also be different offers from the same provider on the same line.

In an embodiment, the first communication connection and the second communication connection have different connection properties. The method then uses the communication connection that suits the requirement of the application variant for the connection.

It goes without saying that the method can be extended to any number of additional communication connections.

Preferably, the first connection property is from one of the following categories:
latency,
jitter,
bandwidth,
availability, and
cost.

Latency is typically specified as round-trip time in milliseconds (ms). Jitter describes the fluctuation range of latency in milliseconds (ms) and is also referred to as packet delay variation. Bandwidth is typically measured in megabits per second (Mbit/s). Availability is typically expressed as a percentage. Cost is typically given in euros per second (euros/s) or euros per gigabyte (euros/GB). The connection property requirements can be a minimum value or a maximum value depending on the category. For example, the bandwidth requirement will typically be a minimum value and the latency requirement will typically be a maximum value.

If there are several ways to meet the requirements, the most cost-effective option is selected.

In an embodiment, the first connection property is determined in an automated manner. Automated determination is made possible in particular for the categories of latency, jitter, and bandwidth by sending test messages via the communication connection. For other categories such as availability and cost, the connection properties are preferably known in advance. It goes without saying that the connection properties of the categories of latency, jitter, and bandwidth can also be known in advance.

In an embodiment, the first communication connection and the second communication connection each have at least two connection properties, and at least one application variant has at least two requirements for different connection properties. By considering several connection properties, the selection of the communication connection is made more suitable to the requirements of the application.

In an embodiment, at least one second application is executed on the first computer, the second application having at least one application variant having requirements for the first connection property, the requirement of the second application being combined with the requirement of the application variants of the first application to form combined application variants having priorities and requirements for the first connection property, steps a) to d) being carried out for the combined application variants. By taking into account the requirement of the second application, the communication connection is selected suitably so that the requirements of both applications are met.

In an embodiment, the second application has at least two application variants having requirements for the first connection property, the requirements of the application variants of the second application being combined with the requirements of the application variants of the first application to form combined application variants having priorities and requirements for the first connection property, steps a) to d) being carried out for the combined application variants. For two or more applications having a plurality of application variants, all possible combinations of the application variants are considered and placed in a prioritized order. For the combinations of application variants, it is then checked in the order of prioritization whether the communication connections can meet the requirements. This ensures that a suitable communication connection is selected for both applications.

Preferably, the priorities of the combined application variants are calculated from the priorities of the application variants of the second application and the priorities of the application variants of the first application. The priorities can be calculated, for example, by adding the individual priorities. For example, four application variants of the first application can have priorities 9, 6, 3 and 0, and three application variants of the second application can have priorities 8, 6 and 0. For the combined application variants, the priorities are thus 9+8, 9+6, 6+8, 6+6, 3+8, 3+6, 9+0, 0+8, 0+6, 6+0, 3+0 and 0+0. In the case of equal priorities, the priority order can depend on another parameter, e.g., an application priority, or can be set randomly. It goes without saying that other calculations can be implemented. For example, priorities can be multiplied. Priorities of applications can also be included in the calculation in addition to priorities of application variants.

In an embodiment, a combined communication connection uses the first communication connection and the second communication connection, and the connection properties of the combined communication connection are calculated from the connection properties of the first communication connection and the second communication connection, the combined communication connection being treated in the method like the first or second communication connection.

The way in which the connection properties of the combined communication connection are calculated can depend on the category. For example, the bandwidth of the combined communication connection can be calculated by adding the bandwidth of the first communication connection and the bandwidth of the second communication connection. When using the combined communication connection with the first and/or second communication connection at the same time, it should be noted that the possible bandwidth of the combined communication connection is reduced by the bandwidth allocated to an application on the first and/or second communication connection. The latency of the combined communication connection can be determined, for example, by determining the maximum value of the latency of the first communication connection and the latency of the second communication connection. If necessary, a predetermined value can be added to the maximum value to calculate the latency of the combined communication connection. The predetermined value takes into account the fact that data sent via the combined communication connection must be split up for transmission via the first communication connection and the second communication connection and must be joined together again at the remote station. The availability can be calculated, for example, by multiplying the availability of the first communication connection and the availability of the second communication connection.

In an embodiment, a third application is executed on the second computer, the third application z having at least two application variants having different requirements for the first connection property, the requirements of the application variants of the third application being combined with the requirements of the application variants of the first application to form combined application variants having priorities and requirements for the connection requirements, steps a) to d) being carried out for the combined application variants.

The requirements of the third application on the second computer are treated in the same way as the requirements of the second application on the first computer. By taking into account the requirements of the third application on the second computer, the requirements on both sides of the connection are taken into account.

The present disclosure also relates to a connecting device for connecting a first computer and a second computer via a first communication connection and/or a second communication connection, wherein the connecting device is connected to the first communication connection and the second communication connection, the connecting device being provided and configured to receive at least one first connection property of the communication connections and requirements for the first connection property of at least two application variants of a first application with a prioritization order, the connecting device being provided and configured to carry out the following steps:
a) selecting the application variant with the highest priority,
b) checking whether the requirements of the selected application variant of one of the communication connections are met,
c) if the requirements of the selected application variant are not met by a communication connection, selecting the application variant with the next lowest priority and repeating the method from step b),
d) connecting the first computer and the second computer via the first communication connection and/or the second communication connection such that the requirements of the selected application variant for the first connection property are met.

The connecting device thus enables a connection between the first computer and the second computer to suit the requirements of the first application. The connecting device can, for example, be designed as a router and be provided for installation between the first computer and the two communication connections. Alternatively, the connecting device can also be part of the first computer. It goes without saying that the connecting device can preferably implement the preferred embodiments of the method according to the present disclosure.

The present disclosure also relates to a system comprising a first computer, a second computer, a first communication connection, a second communication connection and a connecting device, wherein the first computer and the second computer can be connected to one another via the communication connections, the connecting device being provided and configured to establish a connection between the first computer and the second computer via the first communication connection and/or the second communication connection, the first communication connection and the second communication connection each having at least one first connection property, the first computer being provided and configured to execute at least one application, the first application having at least two application variants having different requirements for the first connection property, the application variants having a prioritization order, the connecting device being provided and configured to carry out the following steps:
e) selecting the application variant with the highest priority,
f) checking whether the requirements of the selected application variant of one of the communication connections are met,
g) if the requirements of the selected application variant are not met by a communication connection, selecting the application variant with the next lowest priority and repeating the method from step b),
h) connecting the first computer and the second computer via the first communication connection and/or the second communication connection such that the requirements of the selected application variant for the first connection property are met.

The following description serves to explain embodiments of the present disclosure in greater detail with reference to the drawings.

Elements that are the same or have equivalent functions are denoted by the same reference signs in all the exemplary embodiments.

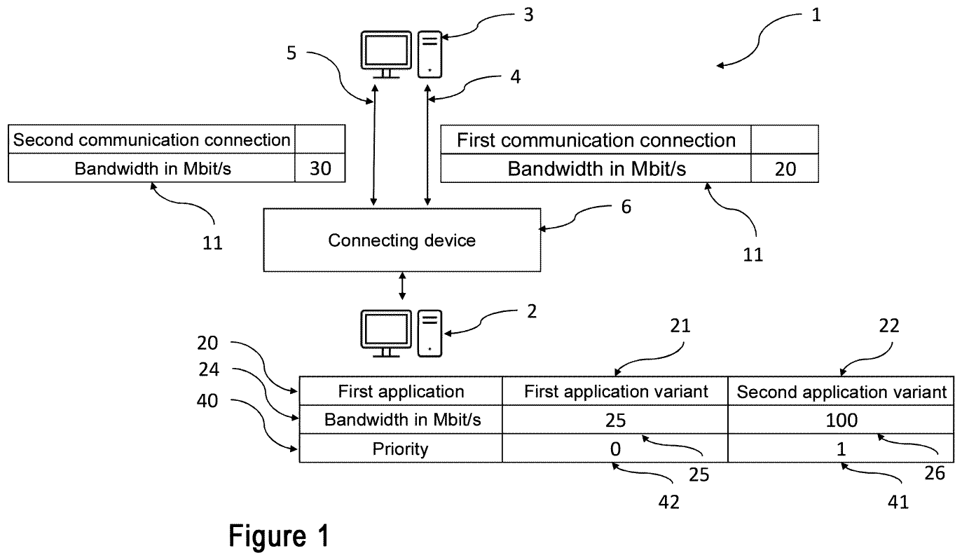

FIG. 1 shows a schematic representation of a system 1 according to the present disclosure. The system 1 comprises a first computer 2, a second computer 3, a first communication connection 4, a second communication connection 5 and a connecting device 6. In this example, the connecting device 6 is connected directly to the first computer 2 and via the first communication connection 4 and the second communication connection 5 to the second computer 3. The connecting device 6 is provided and configured to connect the first computer 2 via the first communication connection 4 and/or the second communication connection 5 to the second computer 3. The first communication connection 4 and the second communication connection 5 each have a first connection property 11, here the bandwidth. The first communication connection 4 has a bandwidth of 20 Mbit/s and the second communication connection 5 has a bandwidth of 30 Mbit/s. A first application 20 is executed on the first computer 2. A first application 20 has a first application variant 21 and a second application variant 22. The application variants 21, 22 have a prioritization order 40. The priority 42 of the first application variant 21 with the value 0 is lower than the priority 41 of the second application variant 22 with the value 1. The second application variant 22 therefore has the highest priority 41. The application variants have different requirements 24 for the first connection properties 11 of the communication connection 4, 5. The first application variant 21 has a requirement 25 of 25 Mbit/s for the bandwidth of the communication connection. The second application variant 22 has a requirement 26 of 100 Mbit/s for the bandwidth of the communication connection.

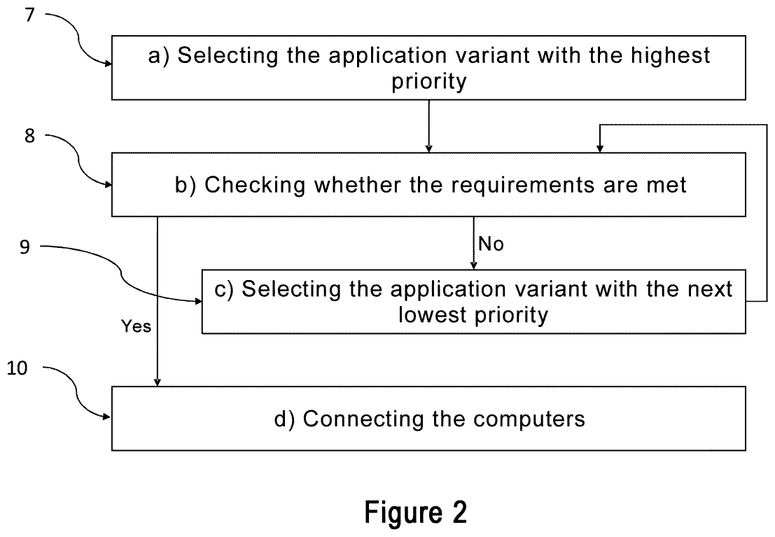

The operating principle of the connecting device 6 is shown below in connection with FIG. 2. FIG. 2 shows a flow chart of a method according to the present disclosure. In a first step 7, the application variant with the highest priority is selected. In the example of FIG. 1, the connecting device 6 selects the second application variant 22 of the first application 20, since this has a higher priority 40 than the first application variant 21. In a second step 8, it is checked whether the requirements 24 of the selected application variant 22 are met by one of the communication connections 4, 5. In the example from FIG. 1, the requirement 26 is a bandwidth of 100 Mbit/s. This requirement is not met by either the first communication connection 4 or the second communication connection 5. Even a connection via both communication connections would not meet the requirement. In a third step 9, the application variant with the next lowest priority is therefore selected. In the example from FIG. 1, the first application variant 21 is selected. The method is then repeated and it is checked from the second step 8 onwards as to whether the requirements 24 of the selected application variant 21 are met by one of the communication connections 4, 5. In the example from FIG. 1, the requirement 25 of the first application variant 21 is a bandwidth of 25 Mbit/s. The requirement 25 is not met by the first communication connection 4. The second communication connection 5 meets the requirement 25. The third step 9 is therefore skipped, and in a fourth step 10 the first computer 2 and the second computer 3 are connected via the second communication connection 5. The computers 2, 3 are thus connected via a communication connection 5 which meets the requirement 25 of the selected application variants 21. Since the connecting device 6 is separated from the first computer 2 here, the connecting device 6 informs the first computer 2 about the properties of the communication connection via which the connection to the second computer is established.

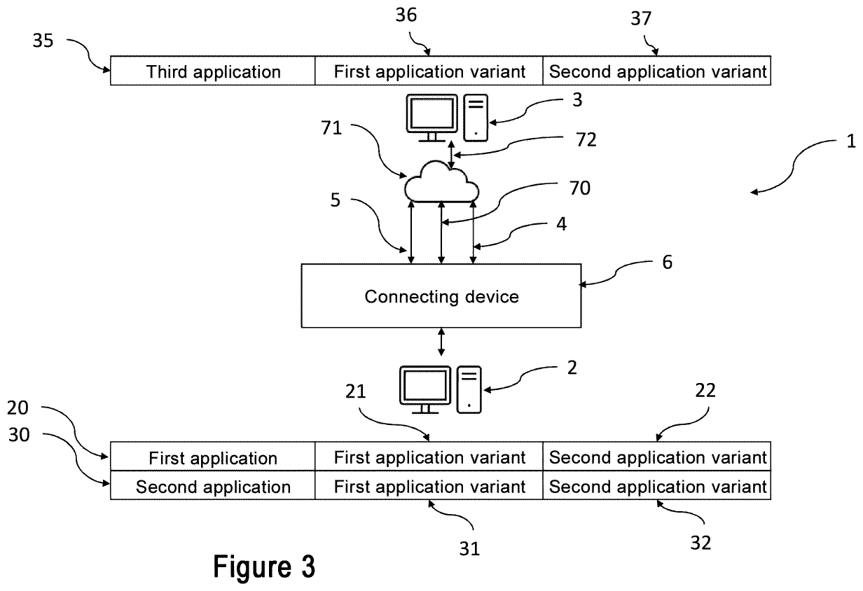

FIG. 3 shows a further schematic representation of a system 1 according to the present disclosure. Only the differences in relation to FIG. 1 are described below. In this example, in addition to the first application 20 having a first application variant 21 and a second application variant 22, a second application 30 having a first application variant 31 and a second application variant 32 is executed on the first computer 2. A third application 35 having a first application variant 36 and a second application variant 37 is executed on the second computer 30. The connecting device 6 is connected via a first communication connection 4, a second communication connection 5 and a third communication connection 70 to the Internet 71. The second computer 3 is connected to the Internet via a fourth communication connection 72. The connecting device 6 can connect the first computer 2 to the Internet 71 and thus to the second computer 3 via the first, second and/or third communication connection.

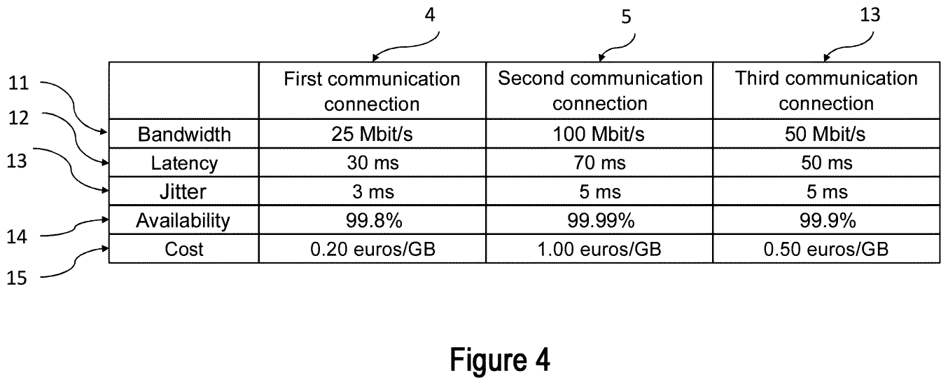

FIG. 4 shows connection properties of the first, second and third communication connections from FIG. 3. Five connection properties are considered for the three communication connections. The first connection property 11 is the bandwidth. The first communication connection 4 has the value 25 Mbit/s for the first connection property 11. The second communication connection 5 has the value 100 Mbit/s for the first connection property 11 and the third communication connection 70 has the value 50 Mbit/s for the first connection property 11. In this example, the bandwidths of the individual communication connections were determined by the connecting device 6 using speed tests of the individual communication connections.

The second connection property 12 is latency. The first communication connection 4 has the value 30 ms for the second connection property 12. The second communication connection 5 has the value 70 ms for the second connection property 12 and the third communication connection 70 has the value 50 ms for the second connection property 12. If a plurality of communication connections are used together as a combined communication connection by an application variant, it should be noted that the latency can increase due to the distribution and merging of the data.

The third connection property 13 is jitter. The first communication connection 4 has the value 3 ms for the third connection property 13. The second communication connection 5 has the value 5 ms for the third connection property 13 and the third communication connection 70 has the value 5 ms for the third connection property 13. In this example, the latencies and jitter of the individual communication connections were determined by the connecting device 6 using what are known as “ping” tests, which measure the round-trip time of communication packets.

The fourth connection property 14 is availability. The first communication connection 4 has the value 99.8% for the fourth connection property 14. The second communication connection 5 has the value 99.99% for the fourth connection property 14 and the third communication connection 70 has the value 99.9% for the fourth connection property 14.

The fifth connection property 15 is the cost. The first communication connection 4 has the value 0.20 euros/GB for the fifth connection property 11. The second communication connection 5 has the value 1.00 euros/GB for the fifth connection property 15 and the third communication connection 70 has the value 0.50 euros/GB for the fifth connection property 15. In this example, the availability and costs of the individual communication connections are values specified by the providers of the individual communication connections.

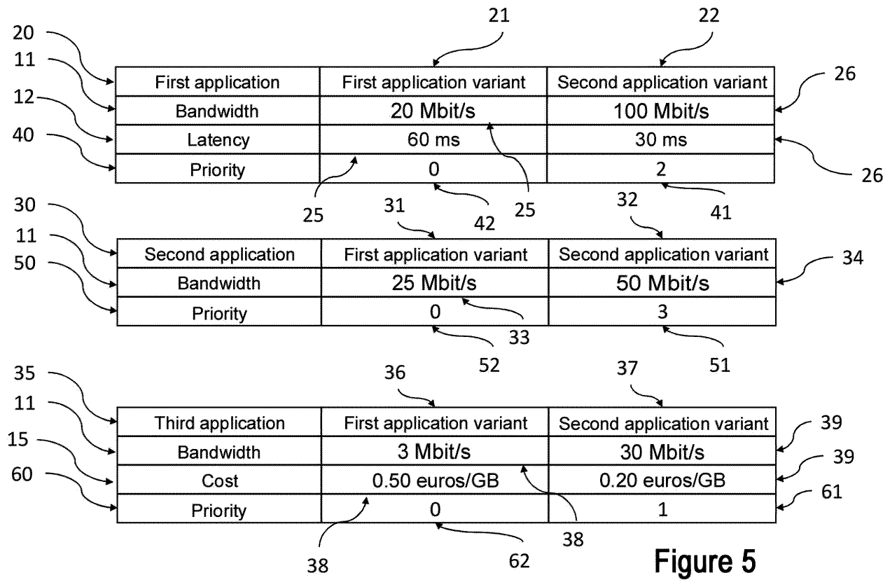

FIG. 5 shows the requirements of the applications from FIG. 3. The first application variant 21 of the first application 20 has a bandwidth of at least 20 Mbit/s as a requirement for the first connection property 11 and a latency of at most 60 ms as a requirement for the second connection property 12. The second application variant 22 of the first application 20 has a bandwidth of at least 100 Mbit/s as a requirement for the first connection property 11 and a latency of at most 30 ms as a requirement for the second connection property 12. The priority of the second application variant 22 has a value of 2 and is thus higher than the priority of the first application variant with a value of 0.

The first application variant 31 of the second application 30 has a bandwidth of at least 25 Mbit/s as a requirement for the first connection property 11 and the second application variant 32 has a bandwidth of at least 50 Mbit/s as a requirement for the first connection property 11. The priority of the second application variant 32 has a value of 3 and is thus higher than the priority of the first application variant with a value of 0.

The first application variant 36 of the third application 35 has a bandwidth of at least 3 Mbit/s as a requirement for the first connection property 11 and a cost of at most 0.50 euros/s as a requirement for the fifth connection property 15. The second application variant 37 of the third application 35 has a bandwidth of at least 30 Mbit/s as a requirement for the first connection property 11 and a cost of at most 0.20 euros/s as a requirement for the fifth connection property 15. The priority of the second application variant 22 has a value of 1 and is thus higher than the priority of the first application variant with a value of 0.

It goes without saying that the requirements are examples and that the application variants can also have requirements for the third and fourth connection properties.

For the three applications 20, 30, 35, each with two application variants, there are eight possible combinations of application variants. In the first step 7, the combination of application variants with the highest priority is selected. In the example of FIG. 5, this is the combination of the second application variant 22 of the first application 22, the second application variant 32 of the second application 30 and the second application variant 37 of the third application 35. The priority of this combination is the result of adding the priorities of the individual application variants and has a value of 6.

In a second step 8, it is checked whether the requirements for the combination of application variants are met by the connection properties of the communication connections. The requirements cannot be met by the connection properties of the communication connections shown in FIG. 3, since the requirements of the second application variants 37 of the third application 35 for a bandwidth of at least 30 Mbit/s at a cost of at most 0.20 euros/GB are not met by a single communication connection or by a combination.

In a third step 9, the combination of application variants with the next lowest priority is selected. In this example, this is the combination of the second application variant 22 of the first application 22, the second application variant 32 of the second application 30 and the first application variant 36 of the third application 35. The priority of this combination is the result of adding the priorities of the individual application variants and has a value of 5.

In a second step 8, it is checked whether the requirements for the combination of application variants are met by the connection properties of the communication connections. The requirements cannot be met by the connection properties of the communication connections shown in FIG. 3, since the requirements of the second application variants 32 of the first application 35 for a bandwidth of at least 100 Mbit/s with a latency of at most 30 ms are not met by a single communication connection or by a combination.

In a third step 9, the combination of application variants with the next lowest priority is selected. In this example there are two combinations with the same priority. On the one hand, there is the combination of the second application variant 22 of the first application 22, the first application variant 31 of the second application 30 and the second application variant 37 of the third application 35. On the other hand, there is the combination of the first application variant 21 of the first application 22, the second application variant 32 of the second application 30 and the first application variant 36 of the third application 35. Both combinations have a priority with the value 3. One of these combinations is randomly selected and the other is tested in the next iteration if necessary. In this example, the combination of the first application variant 21 of the first application 22, the second application variant 32 of the second application 30 and the first application variant 36 of the third application 35 is first checked.

In a second step 8, it is checked whether the requirements for the combination of application variants are met by the connection properties of the communication connections. In this example, there are different possibilities to meet the requirements with the connection properties of the communication connections shown in FIG. 3. A first possibility is to connect the second application variant 32 of the second application 30 via the second communication connection 5 and to connect the first application variant 26 of the third application 35 via the third communication connection 70 and to connect the first application variant 21 of the first application 20 via the first communication connection 4. A second possibility is to connect the second application variant 32 of the second application 30 via the second communication connection 5 and to connect the first application variant 26 of the third application 35 via the first communication connection 4 and to connect the first application variant 21 of the first application 20 via the first communication connection 4. The second possibility generates less cost, and therefore the second possibility is selected.

Since the requirements of the application variants are met, the connecting device 6 connects the first computer 2 and the second computer 3 in a fourth step via the first communication connection 4 and the second communication connection 5.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 System
2 First computer
3 Second computer
4 First communication connection
5 Second communication connection
6 Connecting device
7 First step a)
8 Second step b)
9 Third step c)
10 Fourth step d)
11 First connection property
12 Second connection property
13 Third connection property
14 Fourth connection property
15 Fifth connection property
20 First application
21 First application variant of the first application
22 Second application variant of the first application
24 Requirements of the first application
25 Requirements of the first application variant of the first application
26 Requirements of the second application variant of the first application
30 Second application
31 First application variant of the second application
32 First application variant of the second application
33 Requirements of the first application variant of the second application
34 Requirements of the second application variant of the second application
35 Third Application
36 First application variant of the third application
37 Second application variant of the third application
38 Requirements of the first application variant of the third application
39 Requirements of the second application variant of the third application
40 Prioritizations of the first application
41 Highest prioritization of the first application
42 Second highest prioritization of the first application
50 Prioritizations of the second application
51 Highest prioritization of the second application
52 Second highest prioritization of the second application
60 Prioritizations of the third application
61 Highest prioritization of the third application
62 Second highest prioritization of the third application
70 Third communication connection
71 Internet
72 Fourth communication connection

1. A method for connecting a first computer and a second computer via a first communication connection and/or a second communication connection,
wherein the first communication connection and the second communication connection enable a connection of the first computer and the second computer,
wherein the first communication connection and the second communication connection each have at least one first connection property,
wherein at least one first application is executed on the first computer,
wherein the at least one first application has at least two application variants having different requirements for the at least one first connection property,
wherein the at least two application variants have a prioritization order,
the method comprising:
a) selecting an application variant of the at least two application variants with the highest priority;
b) checking whether the requirements of the selected application variant are met by one of the first and second communication connections;
c) based on a determination that the requirements of the selected application variant are not met by one of the first and second communication connections, selecting an application variant of the at least two application variants with the next lowest priority and repeating the method from step b),
d) connecting the first computer and the second computer via the first communication connection and/or the second communication connection such that the requirements of the selected application variant for the at least one first connection property are met.

2. The method according to claim 1, wherein the first communication connection and the second communication connection have different connection properties.

3. The method according to claim 1, wherein the at least one first connection property is one of latency, jitter, bandwidth, availability, or cost.

4. The method according to claim 1, wherein the at least one first connection property is determined in an automated manner.

5. The method according to claim 1, wherein the first communication connection and the second communication connection each have at least two connection properties, and at least one of the at least two application variants has at least two requirements for different connection properties.

6. The method according to claim 1, wherein at least one second application is executed on the first computer,
wherein the at least one second application has at least one application variant having requirements for the at least one first connection property,
wherein the requirement of the at least one second application are combined with the requirements of the at least two application variants of the at least one first application to form a combination of application variants having priorities and requirements for the at least one first connection property,
wherein steps a) to d) are carried out for the combination of application variants.

7. The method according to claim 6, wherein the at least oen second application has at least two application variants having requirements for the at least one first connection property,
wherein the requirements of the application variants of the at least one second application are combined with the requirements of the application variants of the at least one first application to form a combination of application variants having priorities and requirements for the at least one first connection property,
wherein steps a) to d) are carried out for the combination of application variants.

8. The method according to claim 7, wherein the priorities of the combination of application variants are calculated from the priorities of the application variants of the at least one second application and the priorities of the application variants of the at least two first application.

9. The method according to claim 1, wherein a combined communication connection uses the first communication connection and the second communication connection and the connection properties of the combined communication connection are calculated from the connection properties of the first communication connection and the second communication connection,
wherein the combined communication connection is treated in the method like the first or second communication connection.

10. The method according to claim 1, wherein a third application is executed on the second computer, wherein the third application has at least two application variants having different requirements for the at least one first connection property, wherein the requirements of the application variants of the third application are combined with the requirements of the application variants of the at least one first application to form a combination of application variants having priorities and requirements for the connection requirements, and wherein steps a) to d) are carried out for the combination of application variants.

11. A connecting device for connecting a first computer and a second computer via a first communication connection and/or a second communication connection,
wherein the connecting device is connected to the first communication connection and the second communication connection,
wherein the connecting device is provided and configured to receive at least one first connection property of the communication connections and requirements for the at least one first connection property of at least two application variants of a first application with a prioritization order,
wherein the connecting device is provided and configured to carry out the following steps:
a) selecting an application variant of the at least two application variants with the highest priority,
b) checking whether the requirements of the selected application variant of one of the first and second communication connections are met,
c) based on a determination that the requirements of the selected application variant are not met, selecting an application variant of the at least two application variants with a next lowest priority and repeating steps b) and c),
d) connecting the first computer and the second computer via the first communication connection and/or the second communication connection such that the requirements of the selected application variant for the at least one first connection property are met.

12. A system, comprising:
a first computer;
a second computer;
a first communication connection;
a second communication connection; and
a connecting device,
wherein the first computer and the second computer are configured to be connected to one another via the communication connections,
wherein the connecting device is provided and configured to establish a connection between the first computer and the second computer via the first communication connection and/or the second communication connection,
wherein the first communication connection and the second communication connection each have at least one first connection property,
wherein the first computer is provided and configured to execute at least one first application,
wherein the at least one first application has at least two application variants having different requirements for the at least one first connection property,
wherein the application variants have a prioritization order,
wherein the connecting device is provided and configured to carry out the following steps:
a) selecting an application variant of the at least two application variants with the highest priority,
b) checking whether the requirements of the selected application variant are met by one of the first and second communication connections,
c) based on a determination that the requirements of the selected application variant are not met by the first or second communication connection, selecting an application variant of the at least two application variants with a next lowest priority and repeating steps b) and c),
d) connecting the first computer and the second computer via the first communication connection and/or the second communication connection such that the requirements of the selected application variant for the at least one first connection property are met.
